(19) United States
(12) Patent Application Publication
(10) Pub. No.: US 2014/0133501 A1
(43) Pub. Date: May 15, 2014

(54) PULSED ROTARY DISK LASER AND AMPLIFIER

(71) Applicant: Santanu Basu, Palo Alto, CA (US)

(72) Inventor: Santanu Basu, Palo Alto, CA (US)

(21) Appl. No.: 13/856,983

(22) Filed: Apr. 4, 2013

Related U.S. Application Data
(63) Continuation-in-part of application No. 12/481,225, filed on Jun. 9, 2009, now Pat. No. 8,422,524.

(51) Int. Cl. H01S 3/11

(52) U.S. Cl. CPC H01S 3/11
USPC 372/10; 372/26; 372/18; 372/36

(57) ABSTRACT

There is provided a rotary disk laser module including disk comprised of at least one lasing material. The lasing material may be excited by a laser excitation source, such as an optical pump beam directed onto the disk. The laser gain region contains excited lasing material and extends between the first and second surfaces of the disk. A laser generator is formed when the gain region is brought into optical communication with a laser generator. A laser generator may be a laser oscillator or a laser amplifier. To create pulsed laser output, an optical modulator is positioned in the laser beam propagation path of the laser generator.

### CROSS-REFERENCE TO RELATED APPLICATIONS

This application is a continuation in part application of Non-Provisional patent application with Ser. No. 12/481,225 filed Jun. 9, 2009, titled “Rotary Disk Laser and Amplifier Configurations”, which is in the process of being patented and is not patented yet, and the teachings of which are expressly incorporated herein by reference. In this continuation in part application, the benefit of the aforementioned prior non-provisional patent application is claimed herein.

### STATEMENT RE: FEDERALLY SPONSORED RESEARCH/DEVELOPMENT

(Not Applicable)

### BACKGROUND OF THE INVENTION

1. Field of the Invention

The present invention relates generally to rotary disk lasers and more particularly, to pulsed operations of various laser and amplifier configurations using rotary disk laser module.

2. Description of the Related Art

Laser is a commonly used acronym for light amplification by stimulated emission of radiation. Our modern society utilizes lasers in many different capacities, including but not limited to consumer electronics, medicine, information technology, law enforcement, entertainment and military applications.

Patent application Ser. No. 12/481,225 entitled “Rotary Disk Laser and Amplifier Configurations”, filed on Jun. 9, 2009 discloses various configurations of rotary disk lasers and amplifiers, and is expressly incorporated herein by reference. The benefit of the aforementioned prior non-provisional patent application is claimed herein. U.S. Pat. No. 7,593,447 entitled “Rotary Disk Laser Module” discloses a rotary disk module with an improved efficiency of heat dissipation or heat removal, and is also expressly incorporated herein by reference. The rotary disk module includes a rotary disk that may be used for providing optical gains in one or more laser generators, such as laser amplifiers or laser oscillators. However, the configuration and implementation of the rotary disk laser module may vary depending on the specific use that is desired. U.S. Pat. No. 7,548,573 entitled “Rotary Disk, Rotary Disk Module, and Rotary Disk Laser and Amplifier Configurations”, discloses laser and amplifier configurations which are enabled by rotary disk laser modules.

As is apparent from the foregoing, there exists a need in the art for pulsed rotary disk lasers and pulsed rotary disk amplifiers. The present invention addresses this particular need, as will be discussed in more detail below.

### BRIEF SUMMARY OF THE INVENTION

According to an aspect of the present invention, there is provided a rotary disk laser module including a disk comprised of a lasing material. The disk further includes a first surface, a second surface and a gain region containing excited lasing material. The lasing material may be excited by a pump beam directed onto the disk. The disk may move in order to enable various lasing functionality to the laser module. For instance, the disk may rotate, translate, vibrate or tilt to move the gain region relative to a laser generator and a heat sink to provide various laser effects, or to enable heat transfer with the heat sink.

It is understood that the disk may be used in connection with a variety of laser generators to generate or amplify a laser. Examples of a laser generator include, but is not limited to, a laser oscillator containing a resonator, and a laser amplifier. The rotary disk laser module may include additional mirrors to steer the laser beam, as desired.

An optical modulator may be used in conjunction with a rotary disk laser oscillator or a rotary disk laser amplifier to produce pulsed laser output.

### BRIEF DESCRIPTION OF THE DRAWINGS

These and other features and advantages of the various embodiments disclosed herein will be better understood with respect to the following description and drawings in which like numbers refer to like parts throughout and in which:

FIG. 1 is an exploded view of a laser disk disposed between two heat sinks;

FIG. 2 is a perspective view of a laser disk disposed within a heat sink;

FIG. 3 is a sectional view of a lasing disk having a laser beam directed through a gain region of the disk at the Brewster angle, wherein the laser beam is deflected by first and second mirrors to achieve multiple passes through the disk;

FIG. 3A illustrates a light source emitting a pump beam;

FIG. 3B illustrates an alignment member mechanically coupled to a disk;

FIG. 3C illustrates a laser source emitting a laser beam;

FIG. 4 is a sectional view of a lasing disk having a laser beam directed through a gain region of the disk at an angle other than the Brewster angle, wherein the laser beam is deflected by first, second, third, fourth, fifth and sixth mirrors to achieve multiple passes through the disk;

FIG. 5A is a sectional view of a lasing disk having multiple lasers passing through a gain region;

FIG. 5B is a side sectional view of the lasing disk of FIG. 5A wherein at least one laser is not in a plane that is perpendicular to a first surface of the disk;

FIG. 6A is a sectional view of a lasing disk wherein multiple laser resonators are aligned with a disk gain region to produce multiple laser oscillators;

FIG. 6B is a sectional view of a lasing disk wherein multiple lasers are directed through a disk gain region to amplify the lasers;

FIG. 7 shows the schematic of an optical modulator;

FIG. 8 shows the various forms of modulation that can occur in an optical beam passing through an optical modulator;

FIG. 9 depicts the configuration of a pulsed rotary disk laser oscillator in which the optical modulator is internal to the rotary disk laser oscillator;

FIG. 10 shows the configuration of a pulsed rotary disk laser oscillator in which the optical modulator is external to the rotary disk laser oscillator;

FIG. 11 shows the configuration of a pulsed rotary disk laser amplifier in which the optical modulator is placed in the optical path of the rotary disk laser amplifier;

FIG. 12 depicts the configuration of a pulsed laser oscillator incorporating an optical modulator and a disk which is movable using arbitrary combination of motion patterns including translation, vibration and rotation.

### DETAILED DESCRIPTION OF THE INVENTION

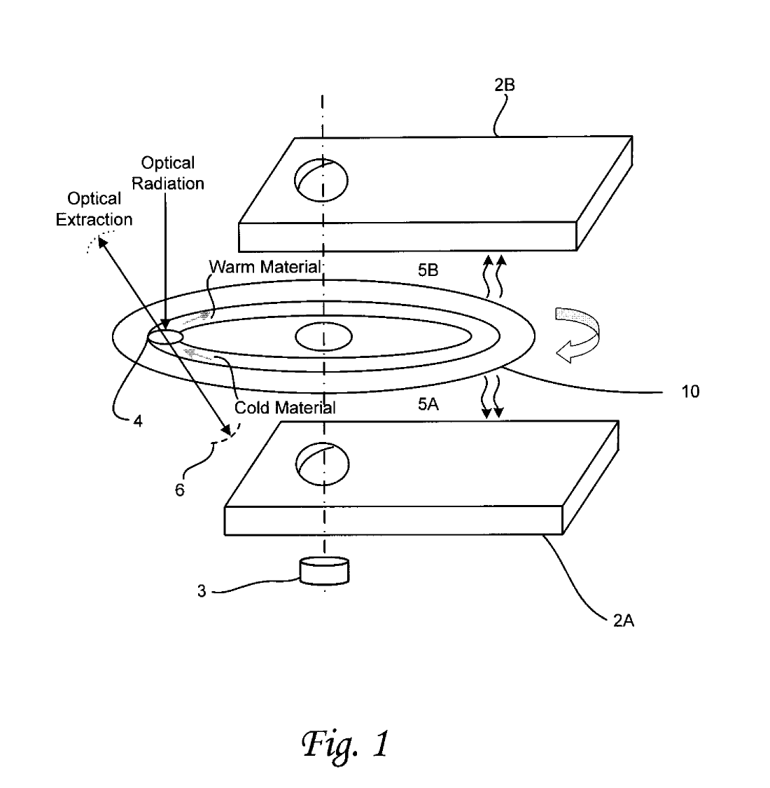

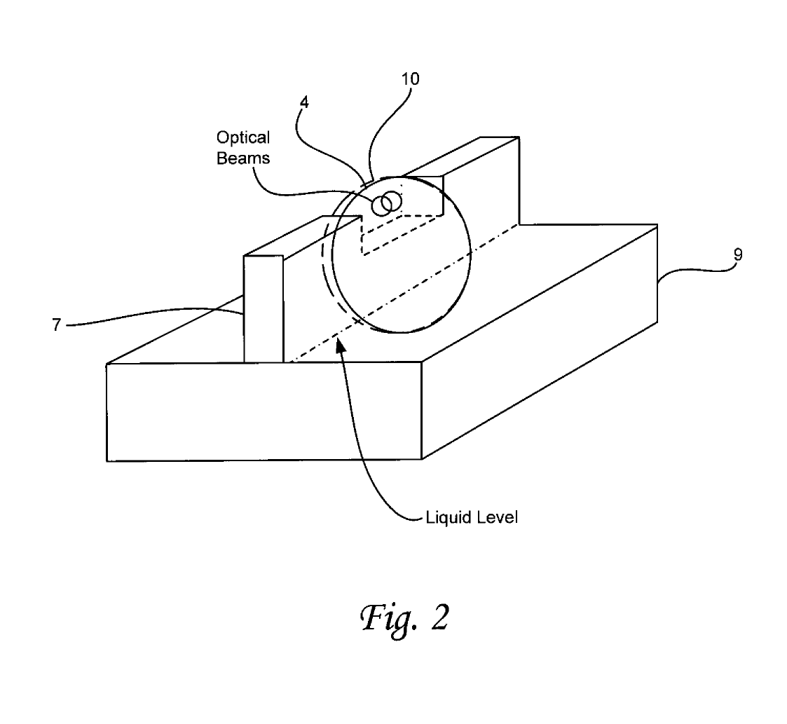

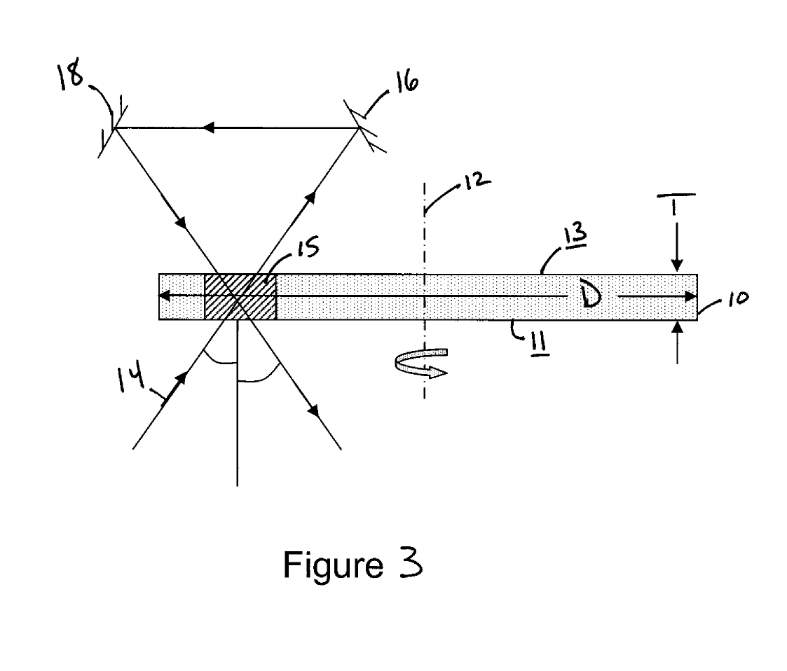

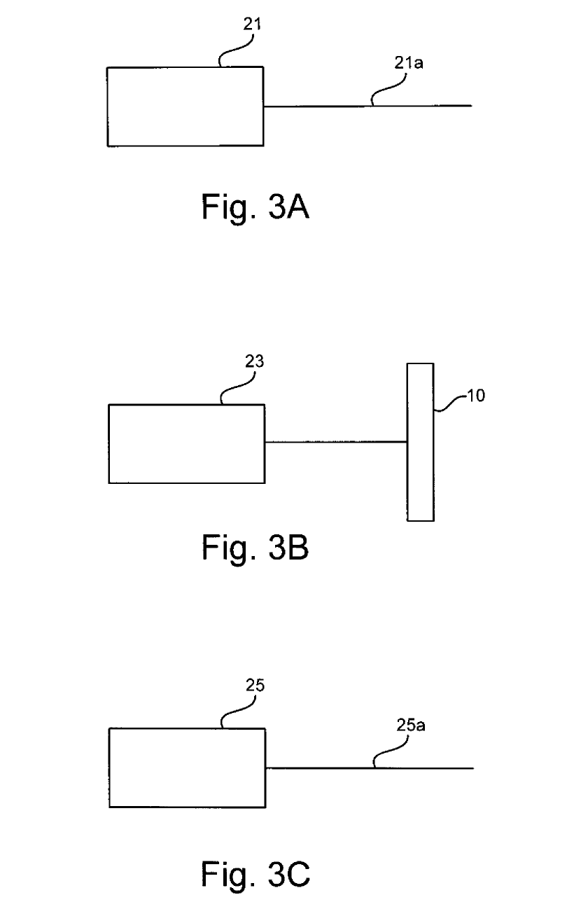

Referring now to the drawings wherein the showings are for purposes of illustrating a preferred embodiment of the present invention only and not for purposes of limiting the same, FIG. 1 depicts an embodiment of a rotary disk laser module. The rotary disk laser module includes a disk 10 comprised of a lasing material disposed within a heat sink. Disk 10, which comprises of a lasing material, may comprise of substrates such as crystalline optical material, ceramic optical material and glass, and which are doped with one or more lasing ions, such as Yb, Nd, Er, Tm and Ho. Examples of crystalline optical materials are YAG, YSGG, YSAG, YGG, YLF, GSGG, GGG, YVO₄, GdVO₄, and sapphire in crystalline form. Example of a ceramic optical material is ceramic YAG. Examples of glass substrate suitable for laser action are phosphate glass and silicate glass of laser optical quality. Disk 10 is attached to a disk displacement mechanism 23, shown in FIG. 3B that can be used to impart disk displacement. The disk displacement can be rotation, translation or combination of both. As used herein, a lasing material is any material that can emit laser light. In the embodiment shown in FIG. 1, a heat sink is disposed substantially adjacent at least a portion of the disk such that as the disk is being displaced, heat from different portions of the disk is transferred to the said heat sink. The heat sink includes first and second portions 2A, 2B. Gaps 5A and 5B are disposed between the disk 10 and the first and second portions 2A, 2B of the heat sink. The disk 10 is positioned within the heat sink such that there is an exposed portion 4. In another embodiment, the exposed portion 4 may be located within a heat sink cutout, as shown in FIG. 2.

At least one laser excitation source is used to create excited lasing material in the disk. One form of laser excitation source is an optical pump source. An optical pump source may be incoherent such as a lamp or coherent such as a laser. A laser pump source may be of many types, including but not limited to solid-state lasers, fiber lasers, gas lasers, and diode lasers. The light from the pump source may be coupled to an optical waveguide, such as an optical fiber, for ease of beam delivery. The light from the pump source or from the optical fiber that is coupled to the pump source may be directly delivered to the disk. The light from the pump source or from the optical fiber that is coupled to the pump source may also be delivered to the disk using one or more optical elements, acting as focusing optic. When optical radiation is directed onto the exposed portion 4 of the disk, a portion of the incident pump beam is transmitted into the disk some of which is absorbed in the disk. A portion of the incident pump beam is reflected from the disk surface. In some cases, a portion of the pump beam is transmitted through the disk without being absorbed. The incident, reflected and transmitted pump beams form a plane. This plane may be oriented at an arbitrary angle with respect to at least one surface of the disk. A portion of the pump beam that is absorbed in the disk excites the lasing material. The portion of the disk 10 containing excited lasing material is referred to as the gain region. When the gain region is aligned with a laser generator 6, a laser is generated. As used herein, a laser generator 6 may be a laser oscillator containing a resonator, laser amplifier, or other laser generators known by those having skill in the art. In the embodiments shown in FIGS. 1 and 2, the disk 10 rotates about a rotation axis to transfer heat to the heat sink portions 2A, 2B. In the embodiment shown in FIG. 1, the disk 10 is driven by a rotation member 3, which may include a motor, however other rotation means may be employed to rotate the disk 10. In another embodiment, the disk 10 may be caused to pass through the heat sink to remove heat from the disk 10.

The heat sink may include gas or liquid to enhance the heat transfer capabilities of the heat sink. As shown in FIG. 2, the heat sink includes a liquid reservoir 9 of a heat transfer liquid. The disk 10 may be cooled by rotating or passing a potion of the disk through the heat transfer liquid in the reservoir. For a more detailed discussion regarding the disk 10 and the heat sink, refer to U.S. Pat. No. 7,593,447, entitled Rotary Disk Laser Module, which is expressly incorporated herein by reference.

It is contemplated that the disk 10 may be used in a variety of configurations. Referring now to FIGS. 3A-3C, in many cases, a disk displacement mechanism 23 moves the disk 10 for a variety of purposes. For instance, the disk 10 may be moved into optical communication with a pump beam 21a or laser beam 25a. FIG. 3B shows a disk displacement mechanism 23 mechanically coupled to a disk 10, thereby enabling the disk displacement member 23 to move the disk 10 as desired. Furthermore, many configurations require a pump beam 21a or laser beam 25a to be directed onto the disk 10. FIGS. 3A and 3C illustrate a light source 21 emitting a pump beam 21a and a laser source 25 emitting a laser 25a.

The following is a description of several configurations in which the disk 10 may be utilized.

### Configuration 1

FIG. 3 depicts an embodiment wherein a laser beam 14 completes multiple passes through the disk 10. It is contemplated that by directing the laser beam 14 to make multiple passes, more energy is extracted from the disk 10. As shown in FIG. 3, the disk 10 is rotatable about a rotation axis 12. The disk 10 may be constructed in a wide range of shapes and sizes. The particular embodiment shown in FIG. 3 includes a disk 10 having a thickness “T” and a diameter “D.” The disk 10 includes opposing first and second surfaces 11, 13. The disk 10 further includes a gain region 15 containing excited lasing material that extends between the first and second surfaces 11, 13.

It is understood that a laser beam can be extracted out of the disk 10 in an infinite number of directions and planes. However, for low-loss operation with an uncoated disk 10, it is advantageous to direct or extract the laser beam at the Brewster angle of incidence. For a given disk 10, there are two distinct directions along which the Brewster angle of incidence is satisfied. Consequently, it would be advantageous to direct a laser or amplifier beam to pass through the gain region 15 of the disk 10 two times by propagating along the two distinct Brewster angle directions with respect to the plane of the disk 10. Double passing of the beam through the disk 10 increases the extraction of the stored energy in the disk 10.

In order to achieve double passing, the embodiment shown in FIG. 3 includes first and second mirrors 16, 18 to reflect the laser beam 14 back through the disk 10. According to one embodiment, the laser beam 14 initially passes through the gain region 15 by entering through the first surface 11 and exiting through the second surface 13. When the beam 14 exits the second surface 13, the beam 14 is deflected by a first mirror 16, as shown in FIG. 3. In one embodiment, the first mirror 16 deflects the beam 14 such that it is substantially parallel to the second surface 13 of the disk 10, however, it is understood that the beam 14 is not required to be deflected substantially parallel to the second surface 13. The beam 14 is then deflected by the second mirror 18 such that it is directed toward the second surface 13 of the disk 10. Preferably, the second mirror 18 reflects the beam 14 toward the disk 10 at the Brewster angle. The beam 14 passes through the gain region 15 of the disk 10 a second time by entering through the second surface 13 and exiting through the first surface 11. As such, double-passing is achieved.

It is understood that first and second mirrors 16, 18 may be used to reflect a beam 14 not entering the disk 10 at the Brewster angle, however, for maximum energy extraction, it is desirable to direct the beam 14 into the disk 10 at an angle that is as close to the Brewster angle as possible.

### Configuration 2

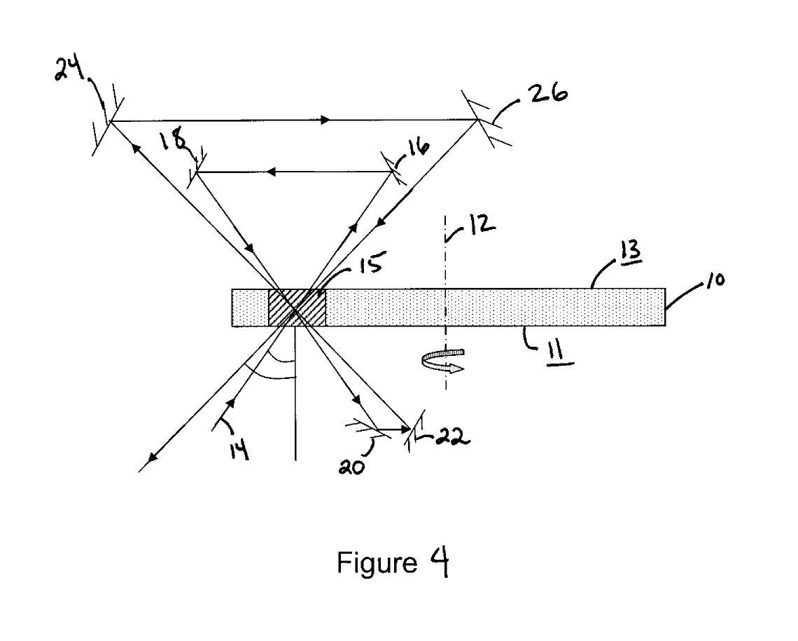

Configuration 1 is useful when the beam 14 enters the disk 10 at the Brewster angle. However, if the beam 14 does not enter the disk 10 at the Brewster angle, it may be desirable to make additional passes through the disk 10 in order to maximize the energy extracted from the disk 10. Therefore, various embodiments of the invention include additional mirrors for directing the beam through the disk. FIG. 4 shows a disk 10 having first, second, third, fourth, fifth and sixth mirrors 16, 18, 20, 22, 24, 26 for achieving multiple passes of the beam 14 through the disk 10.

In the embodiment shown in FIG. 4, the beam 14 enters the gain region 15 of the disk 10 through the first surface 11. The beam 14 exits the disk 10 through the second surface 13 and is deflected by the first mirror 16. The first mirror 16 deflects the beam 14 toward the second mirror 18. The beam 10 is then deflected by the second mirror 18 toward the second surface 13 of the disk 10 at an angle that is close to, but not equal to the Brewster angle. The beam 14 again passes through the gain region 15, exiting through the first surface 11. After exiting through the first surface 11, the beam 14 is deflected by the third mirror 20 toward a fourth mirror 22. A fourth mirror 22 deflects the beam 10 so that it makes an additional pass through the gain region 15 and exists through the second surface 13. After exiting through the second surface 13 for the second time, a fifth mirror 24 deflects the beam 14 toward a sixth mirror 26. A sixth mirror 26 deflects the beam 14 through the gain region 15 again such that the beam 14 enters the disk 10 through the second surface 13 and exits the disk 10 through the first surface 11. In this regard, the beam 14 makes multiple passes through the disk 10 in order to maximize the extraction of energy from the gain region 15.

### Configuration 3

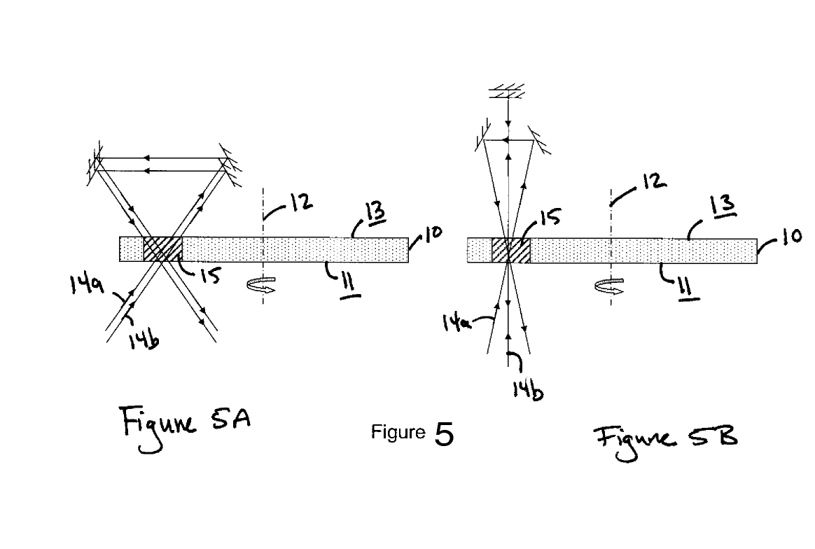

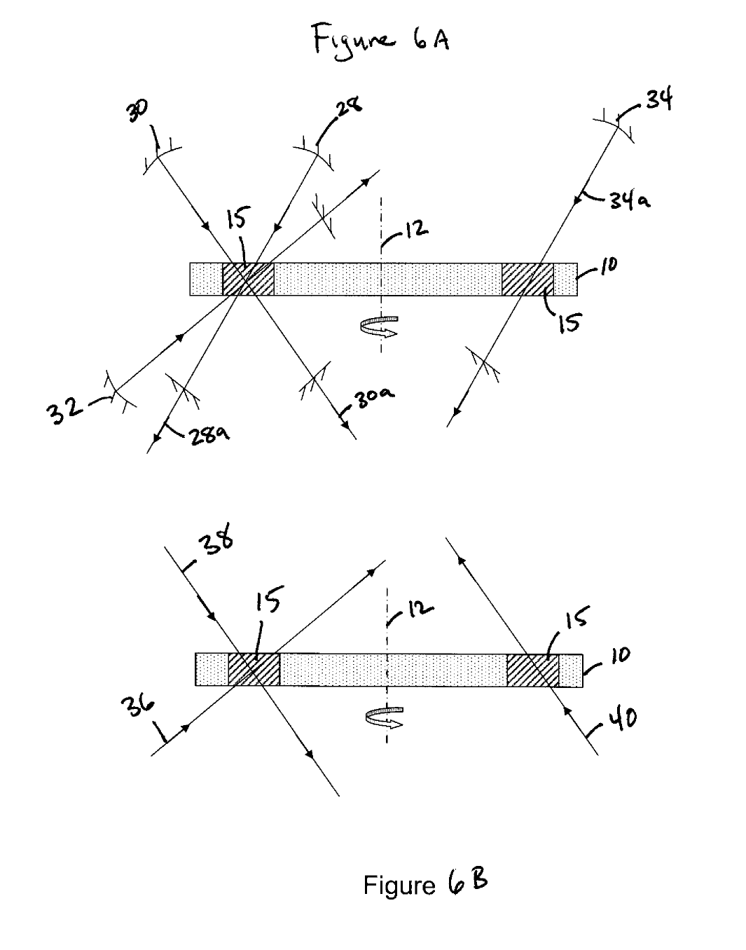

In Configurations 1 and 2, the beams 14 were assumed to be in a plane that is perpendicular to the first and second surfaces 11, 13 of the disk 10. However, it is contemplated that various embodiments of the present invention include laser beams 14a, 14b or pump beams that are not in a plane that is perpendicular to the first or second surfaces 11, 13 of the disk 10. FIG. 5A is a top view of a disk 10 having beams 14a, 14b incident thereon, and FIG. 5B is a side view of the disk 10. As exemplified in FIGS. 5A and 5B, beam 14b is in a plane that is perpendicular to the first surface 11; however, beam 14a is not in a plane that is perpendicular to the first surface 11.

One particular situation in which this may be useful is when a plurality of laser beams are extracted from the disk 10. In this instance at least one of the laser beams may not be in a plane which is perpendicular to the plane of the first and second surfaces 11, 13.

It is also contemplated the certain embodiments of the present invention include pump beams that are in a plane that is not perpendicular to the first or second surfaces 11, 13. This is especially true when a plurality of pump beams are directed onto the disk 10 to multiplex inside the disk 10. In this case, there may be at least one pump beam that is in a plane not perpendicular to the first or second surfaces 11, 13 of the disk 10.

### Configuration 4

Referring now to FIGS. 6A and 6B, it is contemplated that various embodiments of the present invention include a disk 10 that is comprised of a single uniform laser gain medium which can demonstrate laser gain at several wavelengths related to different laser transitions. One particular example of such a lasing material is Nd-YAG. In this type of gain medium, multiple lasers may be constructed out of the same disk 10. The multiple lasers may be of the same or different wavelengths. It is understood that different types of laser generators may be used to generate multiple lasers from the disk 10. It is also understood that various embodiments of the invention have gain regions 15 located at different locations on the disk 10. For instance, in the embodiment shown in FIGS. 6A and 6B, the gain region 15 is on both sides of the rotation axis 12, and lasers 28a, 30a and 34a are extracted on both sides of the gain region 15. Multiple lasers or a single laser may be generated from a single gain region 15.

In one embodiment, multiple laser oscillators may be used to generate multiple lasers. In the embodiment shown in FIG. 6A, there are first, second, third, and fourth oscillators 28, 30, 32, and 34 which generate first, second, third, and fourth lasers 28a, 30a, 32a, and 34a, respectively, which may have different wavelengths. For a Nd-YAG disk, there may be two lasers having a wavelength of 1064 nm, and two other lasers have wavelengths of 1318 nm and 946 nm. In another embodiment, multiple laser amplifiers may use a single disk 10. As shown in FIG. 6B, first, second and third laser amplifiers 36, 38, 40 are amplified by passing through the disk 10. In still another embodiment, there may be at least one laser generator and at least one amplifier generating lasers from the same disk 10.

A laser gain medium capable of demonstrating laser gain at several wavelengths may additionally be used in the double pass configurations described above. For example, a disk 10 comprised of Nd-YAG that is arranged in the double passed configuration 3, the pass 14a may be used to build a 1064 nm laser (4F3/2 to 4111/2 transition), whereas pass 14b may be used to build a 1318 nm laser (4F3/2 to 4113/2 transition).

In the case of a gain medium having a large gain bandwidth, such as Nd-glass or Yb-glass, the laser or the amplifier may be made to operate over multiple wavelengths along multiple propagation directions within the same laser transition.

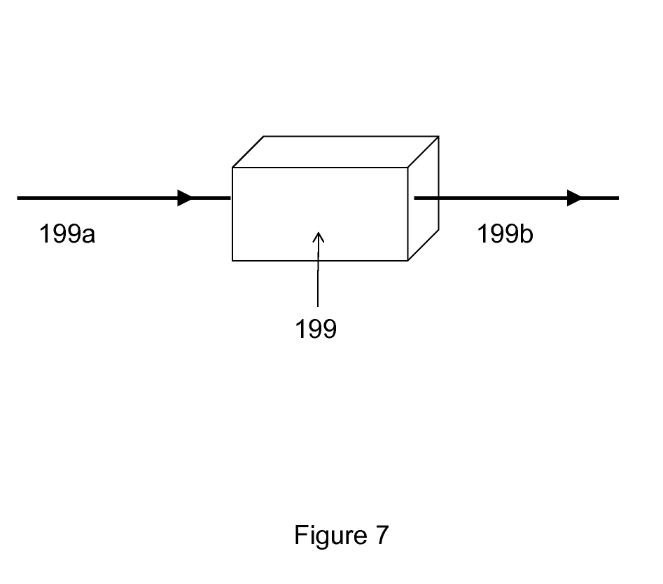

FIG. 7 shows the schematic of an optical modulator 199 which is capable of modulating the amplitude or phase or both amplitude and phase of an optical beam 199a which is incident on the optical modulator. The beam 199b which exits the optical modulator will have different amplitude or different phase or different amplitude and phase from the incident beam 199a. Common examples of optical modulators are acousto-optic modulator, electro-optic modulator, saturable absorbers, passive modulators working on nonlinear optical effects, Q-switches, pulse pickers, phase shifters and mode-lockers.

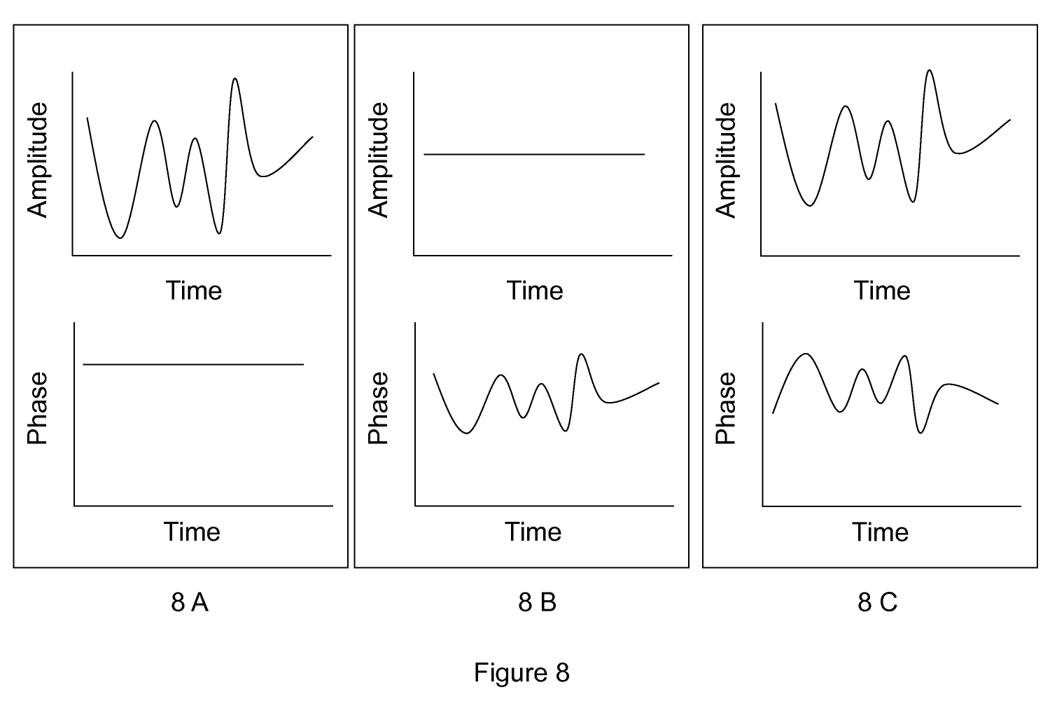

FIGS. 8A-8C schematically show different forms of modulation an optical modulator may impart to an optical beam. In FIG. 8A, the amplitude is modulated in time but the phase remains constant with time. In FIG. 8B, the phase is modulated in time, however the amplitude remains constant with time. In FIG. 8C, both the amplitude and the phase are modulated as functions of time. The time axis is arbitrary, the modulation may occur over attosecond time scale to time scale measured in hours.

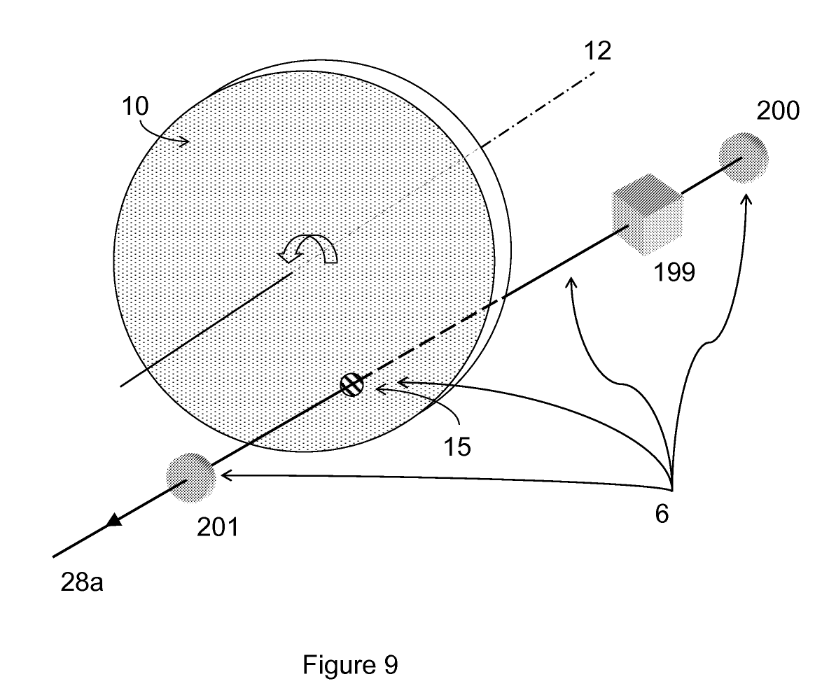

FIG. 9 schematically shows the construction of a pulsed laser with a rotatable disk 10 and optical modulator 199. The disk 10 is rotatable around an axis 12. Disk 10 comprises of a lasing material which is excited to create a laser gain region 15. The laser generator in FIG. 9 is a laser oscillator which comprises of two laser mirrors 200 and 201 and a laser propagation path which is overlapped with the laser gain region 15 in disk 10. In this configuration, the optical modulator 199 is internal to the laser oscillator and it modulates the laser output beam 28a in amplitude, phase or both amplitude and phase. The laser output 28a is pulsed with a time varying intensity, or time varying phase, or time varying intensity and phase.

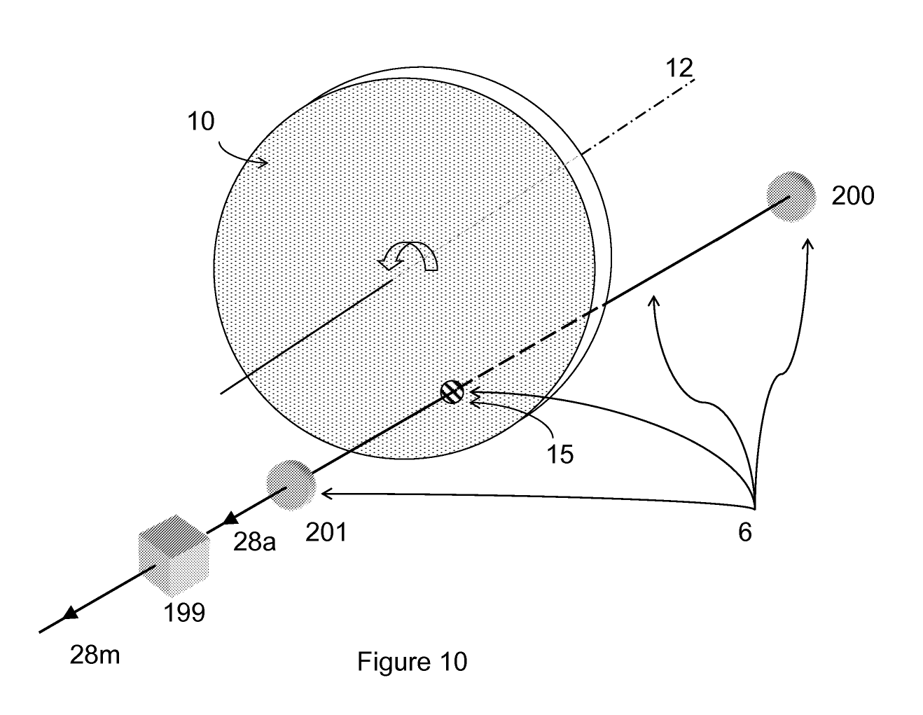

FIG. 10 schematically shows the construction of a pulsed laser, which is similar in construction to the pulsed laser shown schematically in FIG. 9 with the important difference being that in FIG. 10, the optical modulator 199 is external to the laser oscillator which comprises of two laser mirrors 200 and 201 and a laser propagation path which is overlapped with the laser gain region 15 in disk 10. The laser output 28a is modulated by the optical modulator 199 resulting in a pulsed laser output 28m. The laser output 28m is pulsed with a time varying intensity, or time varying phase, or time varying intensity and phase.

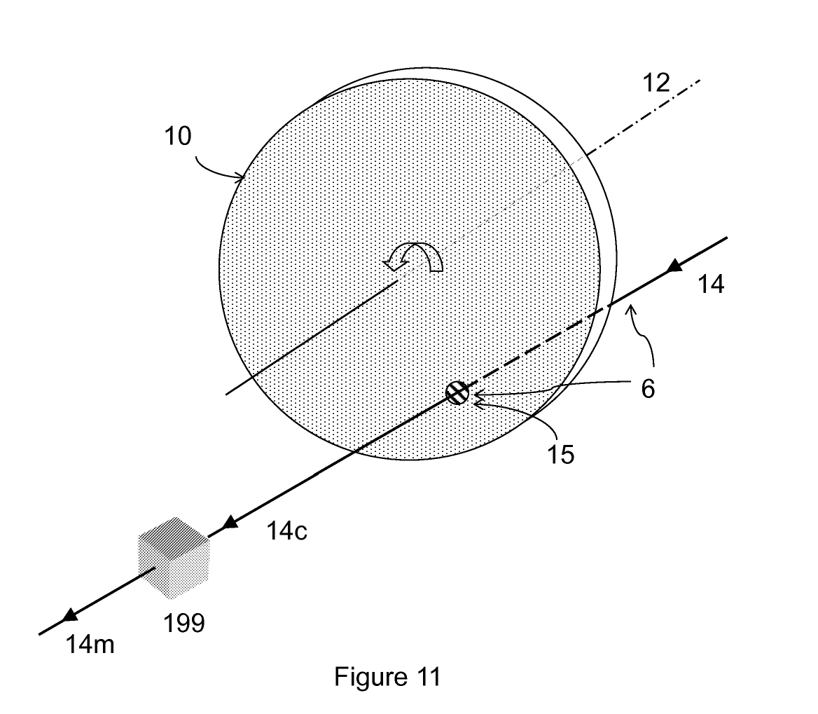

FIG. 11 schematically shows the construction of a pulsed laser, in which the laser generator is a laser amplifier comprising of an incident laser beam 14 along a laser propagation path that partially overlaps with the laser gain region 15 in disk 10. The disk 10 is rotatable around an axis 12, and comprises of a lasing material which is excited to create a laser gain region 15. The laser amplifier generates a laser beam 14c which is then modulated by the optical modulator 199 to produce a pulsed laser beam 14m. The laser output 28m is pulsed with a time varying intensity, or time varying phase, or time varying intensity and phase.

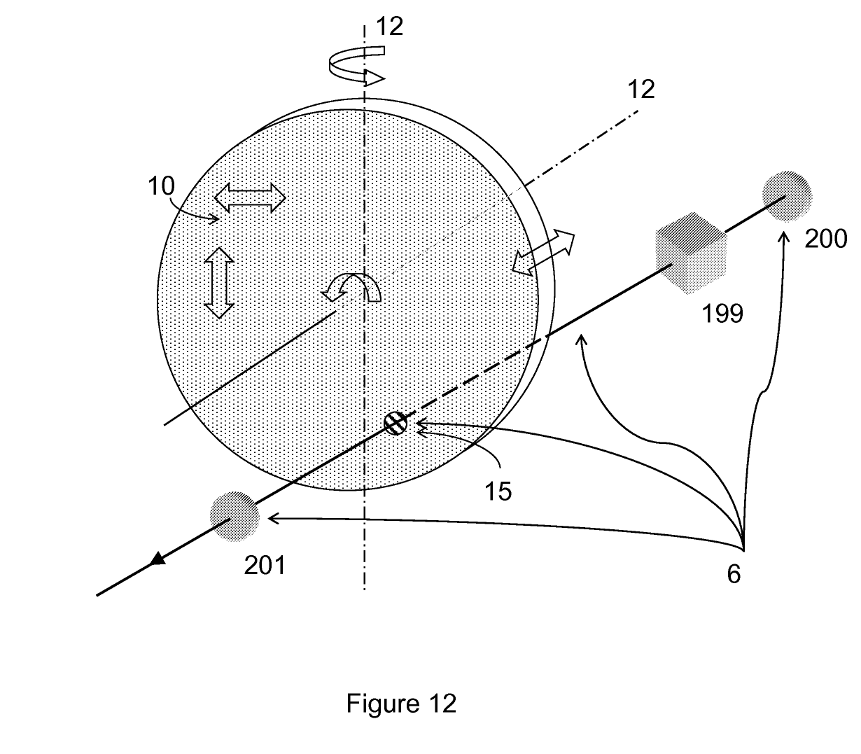

FIG. 12 schematically shows the construction of a pulsed laser with an optical modulator 199, and a disk 10 which is movable using arbitrary combination of motion patterns including translation, vibration and rotation as schematically shown in FIG. 12. Disk 10 comprises of a lasing material which is excited to create a laser gain region 15. To illustrate, the laser generator in FIG. 12 is a laser oscillator which comprises of two laser mirrors 200 and 201 and a laser propagation path which is overlapped with the laser gain region 15 in disk 10. In this configuration, the optical modulator 199 is internal to the laser oscillator and it modulates the laser output beam 28a in amplitude, phase or both amplitude and phase. The laser output 28a is pulsed with a time varying intensity, or time varying phase, or time varying intensity and phase. The disk 10 which is movable using arbitrary combination of motion patterns including translation, vibration and rotation, can also be incorporated in a pulsed laser amplifier as shown in FIG. 11 and a pulsed laser with the optical modulator 199 being external to the laser oscillator as shown in FIG. 10.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A pulsed laser generator comprising:
a disk comprised of lasing material, the said disk having a gain region comprised of excited lasing material;
wherein the said disk is rotatable about a rotation axis;
a rotation member being operative to rotate the said disk;
at least one laser generator in optical communication with the said gain region, the said at least one laser generator being operative to generate a laser beam; and
an optical modulator in optical communication with the said at least one laser generator.

2. The laser module of claim 1 wherein the optical modulator modulates the optical amplitude.

3. The laser module of claim 1 wherein the optical modulator modulates the optical phase.

4. The laser module of claim 1 wherein the optical modulator modulates both the optical amplitude and the optical phase.

5. The laser module of claim 1 wherein the optical modulator is a q-switch.

6. The laser module of claim 1 wherein the optical modulator is a mode-locker.

7. The laser module of claim 1 wherein the said at least one laser generator is a laser oscillator.

8. The laser module of claim 7 wherein the said optical modulator is internal to the laser oscillator.

9. The laser module of claim 7 wherein the said optical modulator is external to the laser oscillator.

10. The laser module of claim 1 wherein the said at least one laser generator is a laser amplifier.

11. The laser module of claim 1 wherein a heat sink is disposed adjacent at least a portion of the said disk such that as the said disk rotates, heat from different portions of the said disk is transferred to the said heat sink.

12. The laser module of claim 1 wherein a disk displacement mechanism translates the said disk.

13. A method of generating a pulsed laser generator, the method comprising the steps of:
a. providing a disk comprised of a lasing material;
b. exciting a portion of the said lasing material in a portion of the said disk to create a laser gain region in the said disk;
c. positioning the laser gain region in optical communication with at least one laser generator to generate a laser beam;
d. step (c) includes rotating the disk; and
e. providing an optical modulator in optical communication with the said at least one laser generator

14. The laser module of claim 13 wherein the optical modulator modulates the optical amplitude.

15. The laser module of claim 13 wherein the optical modulator modulates the optical phase.

16. The laser module of claim 13 wherein the said disk comprises of substrates such as crystalline optical material including YAG, YSGG, YSAG, YGG, YLF, GSGG, GGG, YVO₄, GdVO₄, and sapphire; ceramic optical material including ceramic YAG; and glass including phosphate glass and silicate glass and the said substrates being doped with one or more lasing ions, such as Yb, Nd, Er, Tm and Ho.

17. The method of claim 13 wherein said at least one laser generator is a laser oscillator.

18. The method of claim 13 wherein said at least one laser generator is a laser amplifier.

19. The method of claim 13 wherein at least one pump beam is directed onto the disk to excite the said lasing material to create the said laser gain region.

20. The method of claim 13 wherein the said disk passes through a heat sink to extract heat from the said disk, the heat sink being disposed substantially adjacent at least a portion of the said disk such that as portions of the said disk pass there through, heat from different portions of the said disk dissipates as each portion comes into thermal communication with the heat sink.
